(19) United States
(12) Patent Application Publication
(10) Pub. No.: US 2002/0130972 A1
(43) Pub. Date: Sep. 19, 2002

(54) Television receiver having a notepad/message recorder functionality

(75) Inventor: Marcel Pierre Simons, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/808,191

(22) Filed: Mar. 14, 2001

(51) Int. Cl. H04N 5/44; H04N 5/445

(52) U.S. Cl. 348/553; 348/564

(57) ABSTRACT

A television receiver includes a microphone and an A/D converter for converting a spoken message into a digital signal, and a memory for storing the digital signal. When desired, the stored signal is then converted to a text message and is then displayed on the screen of the television receiver. Alternatively, or in addition, the stored digital message may be reconverted into an electrical audio signal and played by via the loudspeaker of the television receiver.

### BACKGROUND OF THE INVENTION

1. Field of the Invention

The subject invention relates to a television receiver having a messaging capability.

2. Description of The Related Art

Television receivers have become a standard appliance in the homes of consumers. In fact, television receivers are increasingly being used as a display for various function other than the display of, for example, broadcast television programs. These other uses include a computer display, an Internet terminal display, a video game display, etc.

U.S. Pat. No. 5,355,180 discloses a television receiver which includes an audio/visual warning of viewing distance, and which also includes and audio message record/playback function. This television receiver includes a proximity detector for detecting the presence of a person within a predetermined distance of the television screen. Upon such a detection, the television receiver displays a pre-set text message warning the viewer that he/she is too close to the television screen. The television receiver also includes audio message record and playback mode for recording a message of a user and for selectively playing back this message via the audio portion of the television receiver. Alternatively, the audio message may be played back instead of the pre-set text message when a person is detected to be too close to the television screen.

### SUMMARY OF THE INVENTION

It is an object of the invention to provide a television receiver which is capable of visually displaying various spoken messages of the user.

This object is achieved in a television receiver comprising an input for receiving television signals; a tuner connected to the input for selectively tuning the television receiver to one of the received television signals; means coupled to said tuner for processing an audio portion of said one television signal to form an audio signal; a loudspeaker coupled to said audio portion processing means for generating an audible signal from said audio signal; means also coupled to said tuner for processing a video portion of said one television signal to form a video signal; and a display coupled to said video portion processing means for forming a visual picture from said video signal, wherein said television receiver further comprises a microphone for converting a message spoken by a user of the television receiver into an electrical message signal; an analog-to-digital (A/D) converter coupled to the microphone for converting the electrical message signal into a digital message signal; means coupled to said A/D converter for identifying text in said digital message signal and for generating codes corresponding to said text; means coupled to said text identifying means for converting said codes into a video text signal; and means for applying said video text signal to said display, whereby said display shows a text message corresponding to the message spoken by the user.

Applicant has found that there are many times when it is not practical to play back a message aurally, for example, late at night when the sounds of the message may disturb someone sleeping. To this end, the subject invention is capable of converting the spoken message into a text signal which is then displayed on the screen of the television receiver.

In an enhancement of the television receiver of the subject invention, the television receiver further comprises a memory for storing digital signals; a controller coupled to said A/D converter for selectively storing said digital message signal in said memory and for selectively retrieving said stored digital message signal from said memory for application to said text identifying means; and switching operable by the user for causing the controller to store said digital message signal, and for causing the controller to retrieve said stored digital message signal.

Arranged as such, the television receiver is capable of digitally storing the spoken message of the user, and then selectively displaying the text of the spoken message at a time convenient for the intended recipient of the message. To indicate the existence of the message, the television receiver may include indicating means for alerting the intended recipient that there is a stored message.

It is a further object of the invention to provide a television receiver which is capable of selectively playing back various spoken messages of the user either visually or aurally.

This further object is achieved in the television receiver as described above, wherein said television receiver further comprises a digital-to-analog (D/A) converter coupled to an output of said controller for converting the stored digital message signal into a converted electrical message signal; and means for applying said converted electrical message signal to said loudspeaker for generating a audible signal corresponding to said message spoken by the user, wherein said switching means selectively causes said controller to apply said stored digital message signal to either said text identifying means or said D/A converter, or to both said text identifying means and said D/A converter.

### BRIEF DESCRIPTION OF THE DRAWINGS

With the above and additional objects and advantages in mind as will hereinafter appear, the invention will be described with reference to the accompanying drawings, in which:

FIG. 1 shows a block diagram of a television receiver in accordance with the subject invention;

FIG. 2 shows a block diagram of a portion of the television receiver of FIG. 1 showing an incorporated remote control; and

FIG. 3 shows a block diagram of the remote control of FIG. 2.

### DESCRIPTION OF THE PREFERRED EMBODIMENTS

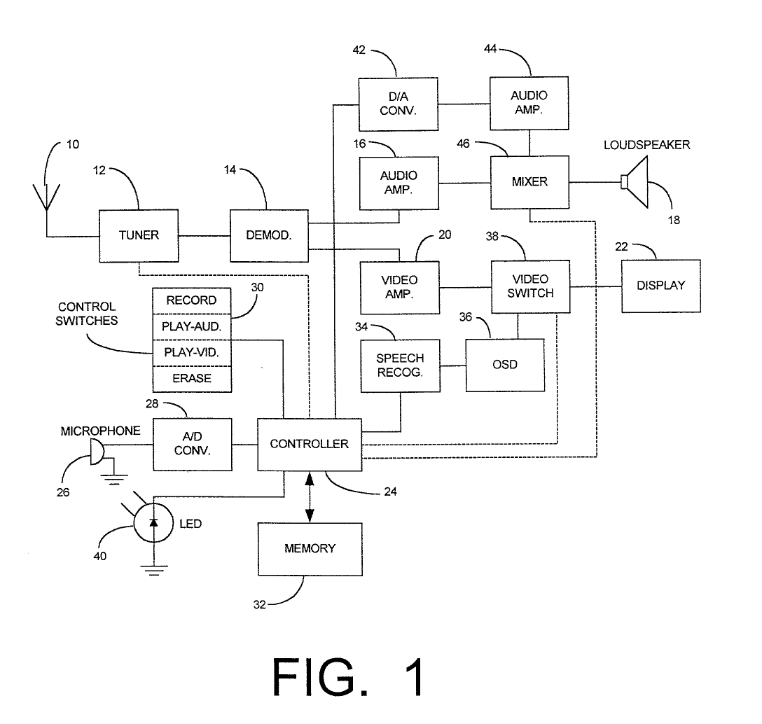

FIG. 1 shows a block diagram of a television receiver incorporating the invention. An antenna 10 receives television signals. Instead of antenna 10, television signals may 20 alternatively be applied from a satellite receiver, a cable system, a video cassette recorder/player, a DVD player, etc. The antenna 10 is connected to a tuner 12 which selectively tunes to one of the television signals received by the antenna 10. An output of the tuner 12 is connected to a demodulator 14 which separates the video from the audio portion of the television signal. The audio portion is applied to an audio amplifier 16 which applies an audio signal to a loudspeaker 18 for generating aural signals. The video portion is correspondingly applied to a video amplifier 20 which applies a video signal to a display 22 for generating visual pictures.

A controller 24 is provided for controlling the tuner 12 to tune to a selected television signal.

In order to record spoken message of a user of the television receiver, a microphone 26 is provided to receive the spoken message and coverts this into an electrical message signal. An analog-to-digital (A/D) converter 28 converts the electrical message signal into a digital message signal which is applied to the controller 24. Under control of control switches 30, the controller 24 writes the digital message signal in a memory 32 connected to the controller 24. A speech recognition circuit 34 is connected to an output of the controller 24 for receiving the digital message signal retrieved from the memory 32 by the controller 24 under control of the control switches 30. The speech recognition circuit 34 converts the digital message signal into a text code signal. This text code signal is then applied to an onscreen display generator 36 for generating a text video signal corresponding to the spoken message.

A video switch 38 is arranged between the video amplifier 20 and the display 22 and includes a second input for receiving the text video signal. Under the control of the controller 24, the video switch 38 switches between the video signal from the video amplifier 20 and the text video signal from the on-screen display generator 36 such that, on the display 22, the visual picture formed by the video signal is overlaid with the text message formed by the text video signal.

The television receiver further includes indicating means in the form of an LED 40 for indicating the presence of a stored message.

In operation, when a user of the television receiver desires to record a message, the user presses and holds a RECORD switch of the control switches 30 and directs the spoken message to the microphone 26. The A/D converter 28 converts the electrical message signal to a digital message signal which is then stored in the memory 32 by the controller 24. The controller 24 then also illuminates LED 40.

When the intended recipient of the message desires to view the message, the intended recipient presses a PLAY-VID switch of the control switches 30 causing the controller 24 to retrieve the stored digital message signal from the memory 32 and to apply this digital message signal to the speech recognition circuit 34. The speech recognition circuit 34 converts the digital message signal into a text code and applies the same to the on-screen display generator 36 which forms a text video signal corresponding to the spoken message. Under control of the controller 24, the video switch 38 applies the text video signal to the display 22 which then displays the text message corresponding to the spoken message. After viewing the message, the intended recipient may then cause the message to be erased from the memory 32 by the controller 24 by pressing the ERASE switch of the control switches 30.

In order that the stored digital message signal may also be heard by the intended recipient, the television receiver further includes a digital-to-analog (D/A) converter 42 connected to the output of the controller 24. The converted electrical message signal from the D/A converter 42 is applied to an audio amplifier 44. A mixer 46 is arranged between the audio amplifier 16 and the loudspeaker 18 and includes a second input for receiving the converted electrical message signal from the audio amplifier 44. The mixer 46 includes a control input for receiving control signals from the controller 24.

When the intended recipient desires to hear the stored message, the intended recipient presses the PLAY-AUD. switch of the control switches 30 causing the controller 24 to retrieve the stored digital message signal from the memory 32 and to apply this digital message signal to the D/A converter 42 and then to the audio amplifier 44. The controller 24 then controls the mixer 46 to apply the reconverted electrical message signal from the audio amplifier 44 to the loudspeaker 18.

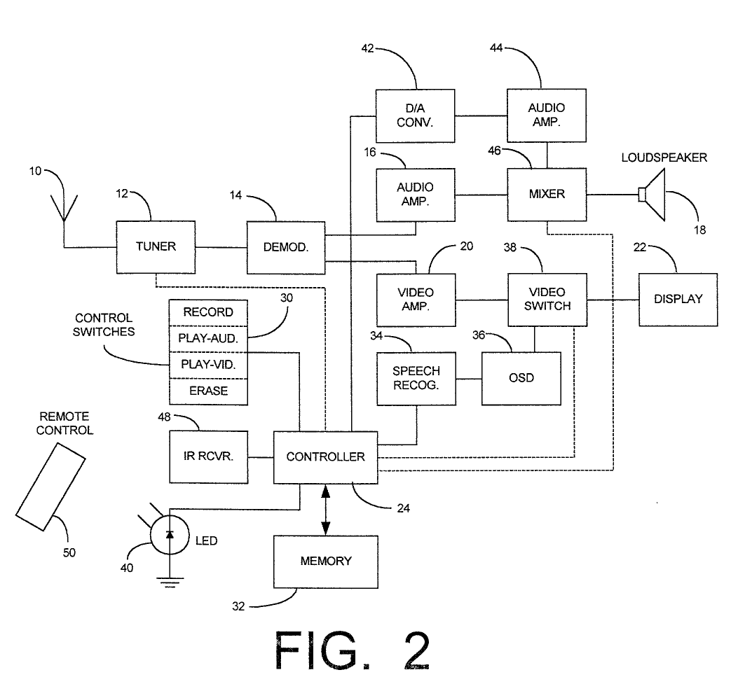

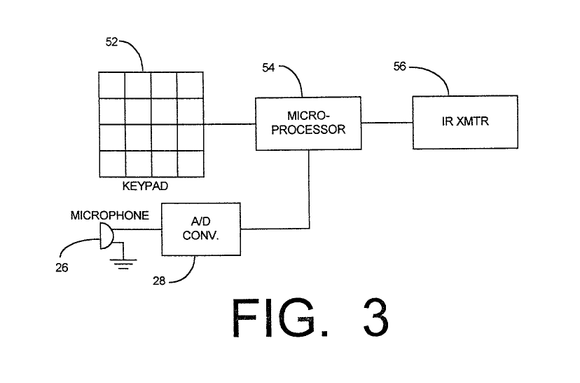

FIG. 2 shows a block diagram of a television receiver substantially similar to that shown in FIG. 1, except that the microphone 26 and the A/D converter 28 are replaced by an infrared (IR) receiver 48 connected to the controller 24 and a remote control transmitter 50 for generating IR signals for the IR receiver 48. As shown in FIG. 3, the remote control transmitter 50 includes a keypad 52 connected to a microprocessor 54. The microphone 26 and the A/D converter 28, shown in FIG. 1, are now included in the remote control transmitter 50, where the output from the A/D converter 28 is connected to the microprocessor 54. An output from the microprocessor 54 is applied to an infrared (IR) transmitter 56 for transmitting the IR signals to the IR receiver 48.

As is well known in the art, by operating various ones of the keys on the keypad 52, the user causes the remote control transmitter 50 to send control IR signals to the IR receiver 48 for controlling the operation of the television receiver through the controller 24. In the event that the user desires to record a message, one of the keys on the keypad 52 is pressed and the user directs the spoken message into the microphone 24 and the microprocessor 54 applied the digital message, along with a control signal, to the IR transmitter 56. This digital message and the control signal are received by the IR receiver 48 and applied to the controller 24. The control signal then causes the controller 24 to store the digital message in the memory 32.

Alternatively to inputting a message via the microphone 24, one of the keys on the keypad 52 of the remote control transmitter 50 may cause the television receiver to display the letters of the alphabet. Then, by controlling a cursor on the television screen using cursor keys on the keypad 52, the user may the “type” the message to be either displayed using the on-screen display generator 36, or, using a synthesizer contained, for example, in the controller 24, played as an audio message. Of course, the keypad 52 of the remote control transmitter 50 may contain sufficient keys to allow the user to directly type in the message.

While the above description only indicates the recording and playing back of a single message, it should be understood that multiple message may be stored and replayed selectively. To that end, the controller 24 may index each message, and then each message may be replayed sequentially or in any order.

Numerous alterations and modifications of the structure herein disclosed will present themselves to those skilled in the art. However, it is to be understood that the above described embodiment is for purposes of illustration only and not to be construed as a limitation of the invention. All such modifications which do not depart from the spirit of the invention are intended to be included within the scope of the appended claims.

What is claimed is:

1. A television receiver comprising:
an input for receiving television signals;
a tuner connected to the input for selectively tuning the television receiver to one of the received television signals;
means coupled to said tuner for processing an audio portion of said one television signal to form an audio signal;
a loudspeaker coupled to said audio portion processing means for generating an audible signal from said audio signal;
means also coupled to said tuner for processing a video portion of said one television signal to form a video signal; and
a display coupled to said video portion processing means for forming a visual picture from said video signal, wherein said television receiver further comprises:
a microphone for converting a message spoken by a user of the television receiver into an electrical message signal;
an analog-to-digital (A/D) converter coupled to the microphone for converting the electrical message signal into a digital message signal;
means coupled to said A/D converter for identifying text in said digital message signal and for generating codes corresponding to said text;
means coupled to said text identifying means for converting said codes into a video text signal; and
means for applying said video text signal to said display, whereby said display shows a text message corresponding to the message spoken by the user.

2. The television receiver as claimed in claim 1, wherein said television receiver further comprises:
a memory for storing digital signals;
a controller coupled to said A/D converter for selectively storing said digital message signal in said memory and for selectively retrieving said stored digital message signal from said memory for application to said text identifying means; and
switching means operable by the user for causing the controller to store said digital message signal, and for causing the controller to retrieve said stored digital message signal.

3. The television receiver as claimed in claim 2, wherein said television receiver further comprises:
an indicator light coupled to said controller, wherein said controller turns on said indicator light when a digital message signal is stored in said memory.

4. The television receiver as claimed in claim 2, wherein said means for applying said video message signal comprises a video switch having a first input coupled to an output of said video portion processing means, a second input coupled to an output of said converting means, an output coupled to said display, and a control input coupled to a control signal output of said controller, wherein said controller selectively activates said video switch such that on said display, said text message overlays a portion of the visual picture formed by said video signal.

5. The television receiver as claimed in claim 2, wherein said television receiver further comprises:
a digital-to-analog (D/A) converter coupled to an output of said controller for converting the stored digital message signal into a converted electrical message signal; and
means for applying said converted electrical message signal to said loudspeaker for generating a audible signal corresponding to said message spoken by the user, wherein said switching means selectively causes said controller to apply said stored digital message signal to either said text identifying means or said D/A converter, or to both said text identifying means and said D/A converter.

6. The television receiver as claimed in claim 2, wherein said controller stores a plurality of digital message signals in said memory, and said switching means controls said controller to retrieve selected ones of said stored plurality of digital message signals from said memory.

7. A television receiver comprising:
an input for receiving television signals;
a tuner connected to the input for selectively tuning the television receiver to one of the received television signals;
means coupled to said tuner for processing an audio portion of said one television signal to form an audio signal;
a loudspeaker coupled to said audio portion processing means for generating an audible signal from said audio signal;
means also coupled to said tuner for processing a video portion of said one television signal to form a video signal; and
a display coupled to said video portion processing means for forming a visual picture from said video signal, wherein said television receiver further comprises:
means for converting a message desired by a user of the television receiver into an electrical message signal;
means coupled to said message converting means for converting said electrical message signal into a video text signal; and
means for applying said video text signal to said display, whereby said display shows a text message corresponding to the desired message.

8. The television receiver as claimed in claim 7, wherein said message converting means comprises an alphanumeric keypad connected to said television receiver.

9. The television receiver as claimed in claim 7, wherein said message converting means comprises:
means for displaying an alphabet on said display;
means for generating a cursor under control of said user;
means for selecting various letters in said alphabet using said controller, whereby said user is able to type the desired message.

10. The television receiver as claimed in claim 7, wherein said television receiver further comprises:
means for converting said electrical message signal into an audio message signal; and means for applying said audio message signal to said loudspeaker.

11. The television receiver as claimed in claim 10, wherein said electrical message signal converting means comprises a speech synthesizer.
